(19) United States
(12) Patent Application Publication
(10) Pub. No.: US 2014/0223471 A1
(43) Pub. Date: Aug. 7, 2014

(54) SIDE CHANNEL CACHING AND TRIGGERING OF CONTEXTUAL ADVERTISEMENTS FOR LIVE BROADCAST VIDEO STREAMING TO MOBILE COMPUTING DEVICES

(71) Applicant: iHigh.com, Inc., Lexington, KY (US)

(72) Inventor: Benjamin A. Askren, Lexington, KY (US)

(73) Assignee: iHigh.com, Inc., Lexington, KY (US)

(21) Appl. No.: 14/173,551

(22) Filed: Feb. 5, 2014

Related U.S. Application Data
(60) Provisional application No. 61/761,149, filed on Feb. 5, 2013.

(51) Int. Cl. H04N 21/458; H04N 21/433; H04N 21/81; H04N 21/234

(52) U.S. Cl. CPC H04N 21/458; H04N 21/23424; H04N 21/4331; H04N 21/812
USPC 725/32

(57) ABSTRACT

In a method for displaying an advertisement in conjunction with the presentation of digital content, providing ad content to the media player for storage in an ad cache prior to the streaming of the digital content. Ad trigger data is provided to the media player during the streaming of the digital content, wherein the ad trigger data includes information indicating at least one of a period of time during which ad content should be presented and a point in time at which the ad content should begin being presented during the streaming of the digital content. The ad content is presented on a display at least one of during the period of time during which ad content should be presented, and at or near the point in time at which the ad content should begin being presented on the display.

### CROSS REFERENCE TO RELATED APPLICATIONS

The present application claims the benefit of U.S. Provisional Application No. 61/761,149 filed 5 Feb. 2013, which is incorporated herein by reference in its entirety.

### FIELD OF THE DISCLOSURE

The present disclosure is directed to the technical field of presenting advertisements to accompany live broadcast video streaming.

### BACKGROUND

Contextual advertising is a form of targeted advertising suited for advertisements appearing on websites or other media, such as content displayed on browsers or mobile browsers. The advertisements may be selected and served through automated means or systems based on content displayed to a user. A contextual advertising system may, for example, scan the text of a website for keywords and return advertisements based on the keywords. Contextual advertising may also be used by search engines to display advertisements on search pages.

### SUMMARY

The present disclosure is directed to a method of using side channel streams for the purpose of injecting contextual advertisements into live broadcast video streams. The present disclosure provides a description of how side channel streams can be used to inject contextual advertisements in a manner that minimizes peak bandwidth consumption and latency delays in switching between the live broadcast steam and advertisement units.

Additional advantages and novel features will be set forth in part in the description which follows, and in part will become apparent to those skilled in the art upon examination of the following and the accompanying drawings or may be learned by production or operation of the disclosed embodiments. The advantages of the present embodiments may be realized and attained by practice or use of various aspects of the methodologies, instrumentalities and combinations set forth in the detailed description set forth below.

### BRIEF DESCRIPTION OF THE DRAWINGS

FIG. 1 shows an embodiment of a system for delivering a live broadcast video stream with mid-roll advertisements to a media player.

FIG. 2 shows a process according to the system of FIG. 1 for Live Broadcast Video Streaming.

FIG. 3 shows a first method of injecting Ad Units into a Live Broadcast Video Stream.

FIG. 4 shows a second method of injecting Ad Units into a Live Broadcast Video Stream.

FIG. 5 shows a system according to another embodiment.

FIG. 6 shows an embodiment of a process of initiating a Live Broadcast Video Stream.

FIG. 7 shows an embodiment of a process of injecting an ad unit into a Live Broadcast Video Stream.

FIG. 8 depicts a high-level block diagram of a computer for implementing embodiments of the present disclosure.

### DETAILED DESCRIPTION

A video stream is defined herein as a continuous flow of digitally encoded audio and video data from one digital device to another. Video streaming is furthermore defined herein as the act of creating and maintaining a video stream. Examples include video streaming from a network-connected server to a digital television, digital video recorder, personal computer or mobile computing device or video streaming from a content provider to a network-connected server. A display includes any device for presentation of digital content, including, for example, a video monitor, a audio speaker, a projection screen, a television, a computer monitor, a movie screen, a headset, an ear bud, headphones, and any other device that presents sounds that can be heard or sensed and/or images that can be seen.

A live broadcast video stream is a video stream of a live event or performance. Live broadcast video streaming refers to the act of creating and maintaining a live broadcast video stream. The purpose of live broadcast video streaming is to present video in a form that appears to the end user the same as a traditional live radio or live television broadcast.

An video advertisement is a form of content that presents information to a viewer regarding a product or a service of the provider of the service or product. A mid-roll video advertisement is a video advertisement that is presented to the viewer, not before or after a video stream, but during a video stream, for example, during a break in content of a video stream. While common in commercial television broadcasts, there are numerous technical challenges to presenting mid-roll video advertisements in live broadcast video streams. Ad triggering is the process of requesting a mid-roll advertisement for a live broadcast video stream. An ad trigger is a command or signal that requests, causes or results in the initiation of a mid-roll video advertisement. Advertisement injection (ad injection) is the multistep process of responding to an ad trigger and presenting a mid-roll video advertisement. Because of the nature of live broadcast video streaming, ad injection is optimally implemented as a real time process.

A Mobile computing device is defined herein as a battery powered portable computer, smartphone, PDA, or digital media player/viewer, with a screen as the primary visual output device. Examples include portable music and multimedia devices like Apple's iPod Touch, touch screen mobile computing device or tablets like Apple's iPad, and Samsung Galaxy, and smart phone devices like Apple's iPhone, Motorola and HTC Droid phones, the Blackberry Curve, and Samsung's Galaxy line phones, notebook, laptop and netbook computers. Mobile computing devices are often capable of facilitating network connections to both WiFi and cellular networks and have very low computing power requirements when compared to personal computers.

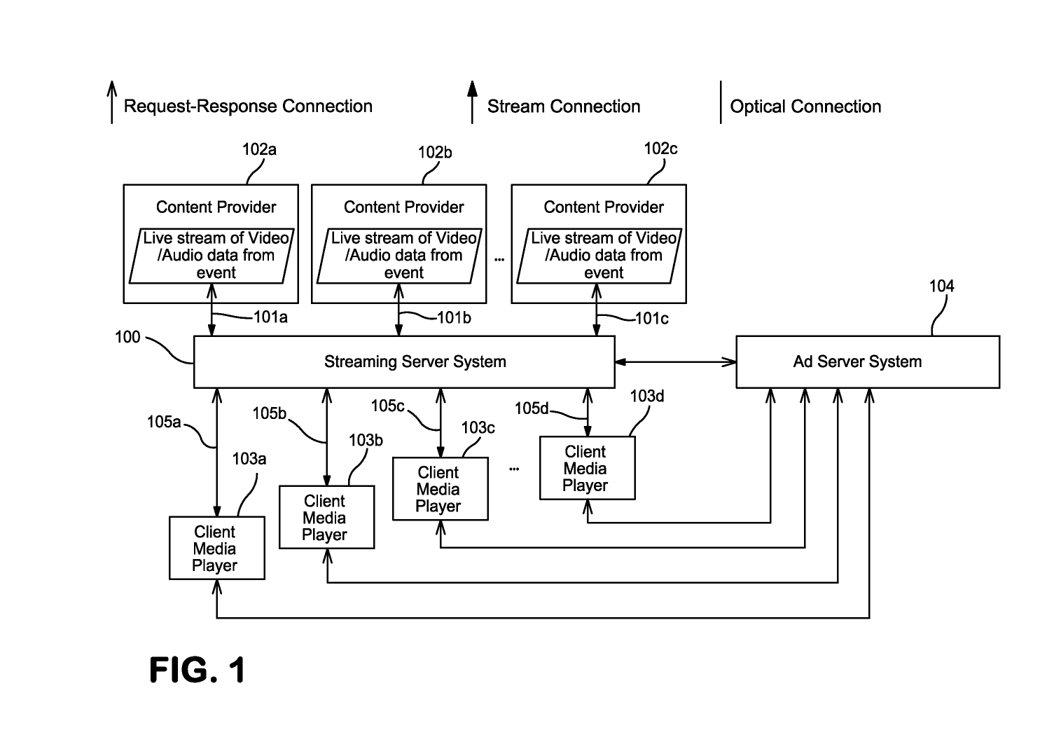

FIG. 1 illustrates exemplary systems, connected by digital networks, used in delivering a live broadcast video stream with mid-roll advertisements to a client media player, in this example a mobile computing device. The streaming server system 100 is a system of networked computing devices, capable of receiving one or many video streams 101a-101c (also referred to as the content) from content providers 102a-102c and, in turn, broadcasting video streams 105a-105d of the same content to client media players 103a-103d.

A content provider 102 is defined herein as a system by which a video stream of an event or performance is created and/or provided to a streaming server system. For a given live broadcast video stream, the relationship between content provider 102 and a streaming server system 100 is typically one to one. However, other configurations and relationships between content provider 102 and streaming server system 100, such as, for example, one to many, many to many and many to one, may be implemented.

The ad server system 104 is a system that provides, on demand, ad units to a requesting device. An ad unit comprises metadata and creative content and is a reference to the audio, video, image and/or script files that can be used to present an advertisement in a client media player 103. The ad unit metadata includes, for example, the standard information provided in the advertising industry, and/or can include specific information for controlling and managing the display of advertisements. For a given ad unit, the relationship between ad server system 104 and requesting devices is typically many to many. A client media player 103 is defined herein as a digital device or software application on a digital device, or a combination of both, that can receive a video stream from a streaming server system 100 and decode it for user presentation, such that a user can experience it as audio and/or video. For a given live broadcast video stream, the relationship is usually one streaming server system 100 to many client media players 103. However, other configurations and relationships between streaming server systems 100 and client media players 103, such as, for example, many to many, may be implemented.

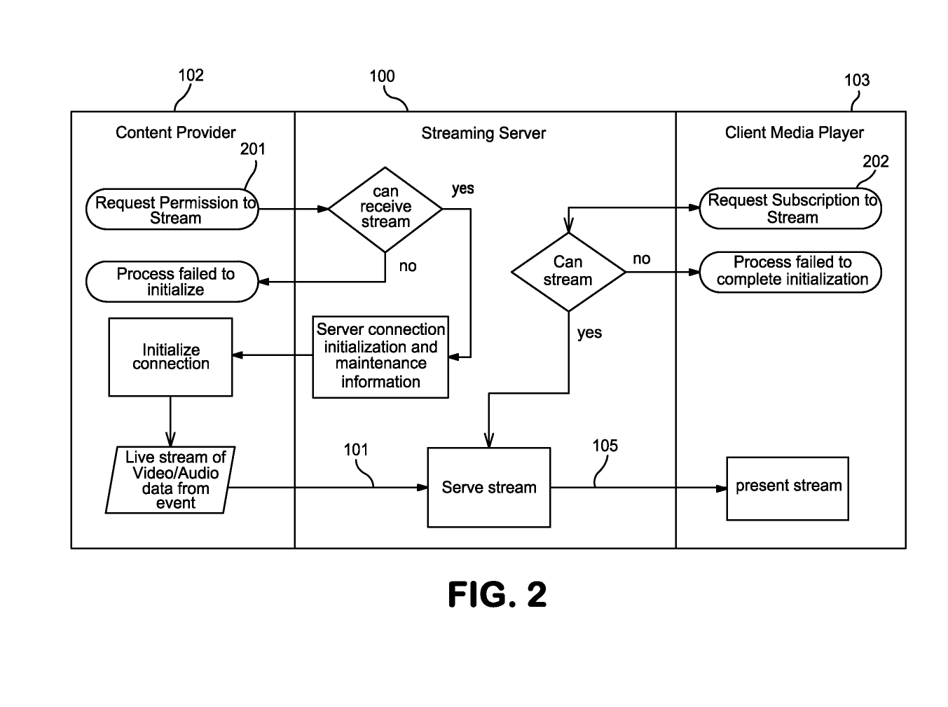

There are a number of approaches to Live Broadcast Video Streaming. One embodiment is described herein as a process, and is illustrated in FIG. 2. First, the Content Provider 102 requests permission to deliver a Live Broadcast Video Stream 101 (referred to herein as the Video Stream) to a Streaming Server System 100. If the Streaming Server System 100 cannot accept the Video Stream 101, it rejects the request and initialization of the process is not started. If the Streaming Server System 100 can accept the Video Stream 101, the Streaming Server System 100 responds to the Content Provider 102 with information to initialize and maintain the Video Stream 101 to the Streaming Server System 100. The system monitors when the Video Stream is completed. If not completed, the system continues to monitor until it determines that the Video Stream has completed. Upon completion, the process is terminated. Likewise, a Client Media Player 103 can request a subscription 202 to the Video Stream 101 from the Streaming Server System 100. If the Streaming Server System 100 cannot provide the Video Stream 101 (for example, because the Content Provider 102 has yet to provide the Video Stream 101 to the Streaming Server System 100), the Streaming Server System 100 rejects the request and the process does not complete initialization. If the Streaming Server System 100 can provide the Video Stream 101, the Streaming Server System 100 sends the Client Media Player 103 information to initialize and maintain the Video Stream 101 from the Streaming Server System 100. With a Video Stream 101 from the Content Provider 102 to the Streaming Server System 100 and in turn from the Streaming Server System 100 to one or more Client Media Players 103, the process of Video Streaming is considered ongoing until completion.

Because a Live Broadcast Video Stream is a continuous flow of data from a live event, it presents several unique problems not found when Streaming a pre-recorded Video Stream to a Client Media Player 103. As with pre-recorded Video Streams, content providers very often wish to provide the highest quality viewing experience while generating revenue from advertisers. One approach to this is by injecting Mid-Roll Video Advertisements and/or Banner Advertisements at carefully chosen break points in the Video Stream. There are many approaches to determining when to inject such advertisements in Pre-recorded Video Streams but, for Live Broadcast Streaming, the primary approach is for Content Provider 102 to trigger the injection of Ad Units in reaction to the details of the event being broadcast. For example, a Content Provider 102 will trigger the injection of Ad Units in response to a time out during a sporting event or between acts of a play.

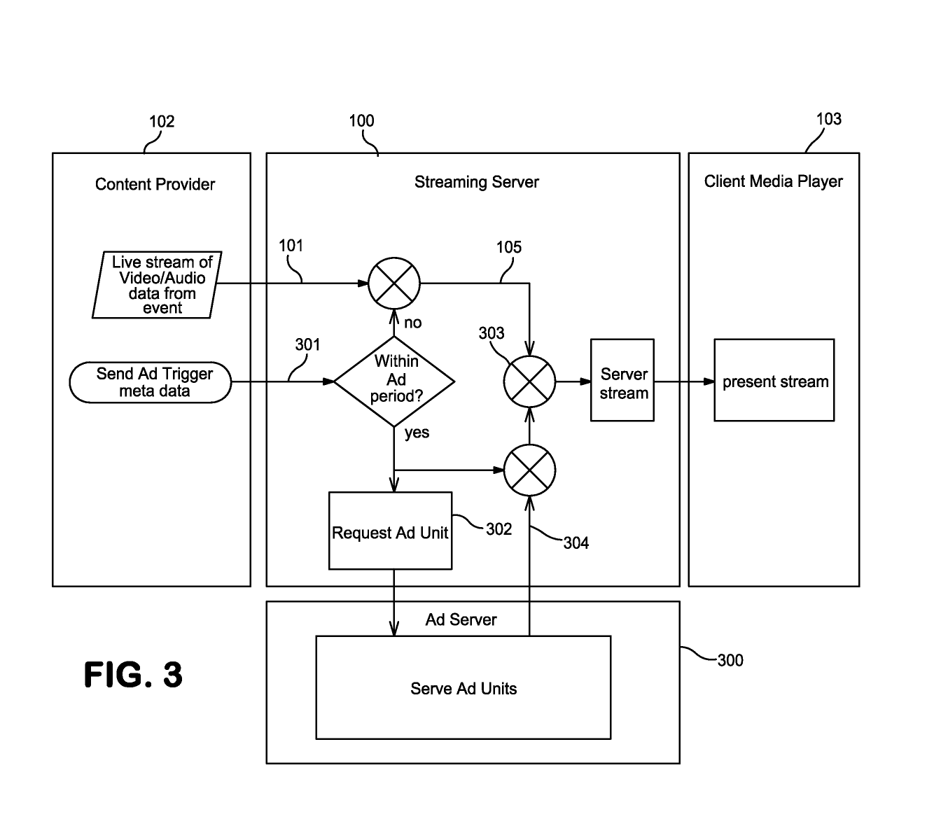

Assuming the above description of a Live Broadcast Video Stream process, FIG. 3 illustrates one approach (hereby called Approach A) of injecting Ad Units into a Live Broadcast Video Stream. The injection process starts with the Content Provider 102 sending Ad Trigger Meta Data 301 to the Streaming Server System 100. The Ad Trigger Meta Data 301 includes, but is not limited to, the point in time in which the Video Stream needs one or more advertisements injected and duration of the injection. The Streaming Server System 100 in turn sends request 302 for a number of Ad Units 304 from the Ad Server System 300, typically enough to fill the duration specified by the Ad Trigger Meta Data 301, and then, in lieu of the Content Provider's Stream 105, the Streaming Server System 100 streams the Ad Units 304 to the Client Media Player.

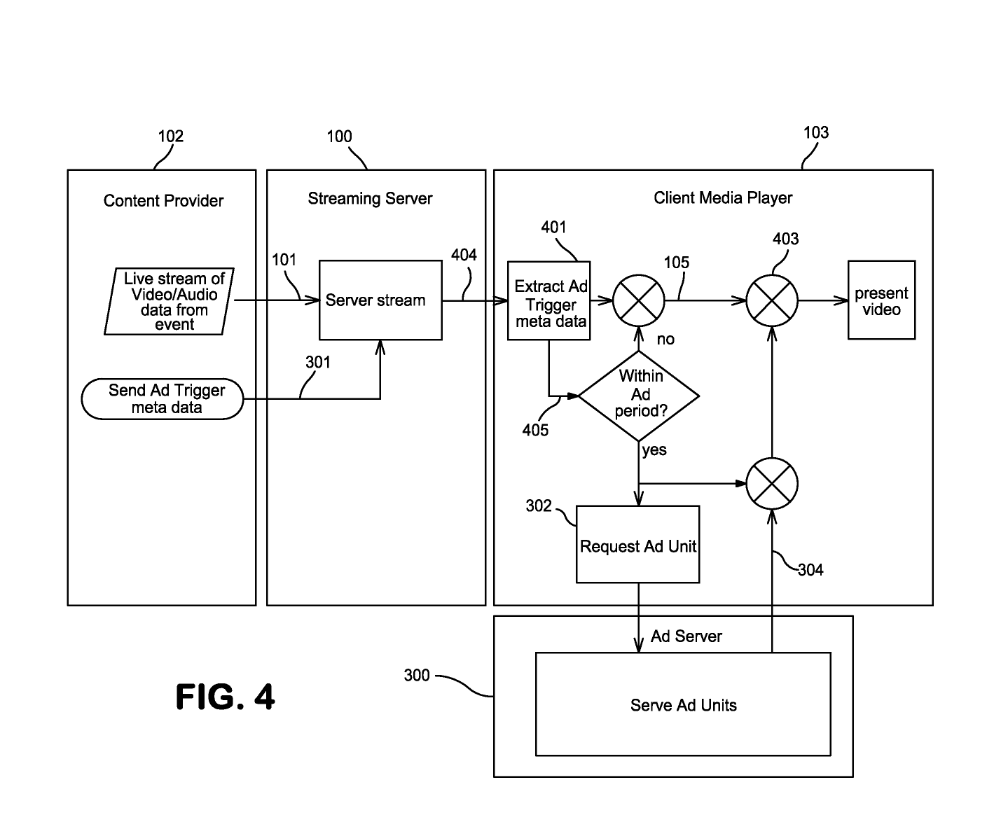

Alternatively, FIG. 4 illustrates another approach (hereby called Approach B) of injecting Ad Units into a Live Broadcast Video Stream. This embodiment also starts with the Content Provider 102 sending an Ad Trigger Meta Data 301 to the Streaming Server System 100. In turn, the Streaming Server System 100 embeds the Ad Trigger Meta Data 301 into the Live Broadcast Video Stream 404 it is sending to the Client Media Player 103. For example, some Streaming Server Systems 100, designed for use with proprietary Client Media Players 103, embed the Ad Trigger Meta Data 301 into the Closed Captioning Channel of the Live Broadcast Video Stream, resulting in a Hybrid Video Stream 404 with the Video Stream 101 and Ad Trigger Meta Data 301 combined. With this approach, the Client Media Player 103 will filter 401 the Hybrid Video Stream 404 to extract Ad Trigger Meta Data 405 from the Content Provider's Stream 105. Once Ad Trigger Meta Data is detected and extracted, the Client Media Player 103 sends a request 302, for Ad Units 304 from the Ad Server System 300 and performs the injection 403 of the Ad Unit into the video presentation in place of the Content Provider's Stream 105.

A major advantage of Approach B compared to Approach A is the ability to select injected Ad Units 304 based on Consumer Context and Device Context. Consumer Context refers to information the Live Broadcast Video Stream Consumer chooses to share with the Ad Server System 300 with respect to preferences, location, relationships to others, etc. Device Context refers to information about the Client Media Player such as screen size, processing capabilities, scripting abilities, and other capabilities and functionality of the Client Media Player, that can be shared with the Ad Server System. In Approach A, because the Streaming Server System 100 controls Ad Injection 303 and because of the one Streaming Server System to many Client Media Players relationship, Ad Units cannot be customized beyond the Broadcast and Streaming Server Context. However in Approach B, because the Client Media Player 103 controls Ad Injection 403 and because of the many to many relationship between Client Media Players 103 and Ad Server Systems 300, the Client Media Player 103 is capable of communicating Consumer and Device Context, in addition to the Broadcast and Server Contexts, to a number of Ad Server Systems 300 and therefore enable the choice of the best Ad Units 304 for the Video Consumer.

However, there are also performance implications to using Approach B. First, the Ad Trigger Meta Data 301 is received in real time with the Live Broadcast Video Stream 101. This means the Ad Trigger Meta Data 301 is not received until close to the moment when Ad Injection 403 is to commence. Because the request 302 to the Ad Server System 300 for the Ad Units 304 to be injected is initiated at nearly the same time as the Ad Trigger Meta Data 405 start point is received, any network latency and processing by the Client Media Player 103 is likely to result in a delay in the start of acquisition and rendering of Ad Units. Also, on certain cellular networks, bandwidth and port limitations dictate that a Live Broadcast Video Stream 404 must be closed in order to acquire the Ad Units 304. If this is the case, after the Ad Units have been rendered, re-initializing the Live Broadcast Video Stream can create another delay caused by network latency. As last mile internet service provider bandwidth and personal computer speed have improved, latency and bandwidth issues have been mitigated to the point at which it is practical for Live Broadcast Video Streaming to be used with On-line video players using personal computers. However, for the foreseeable future, this is not the case for Mobile Computing Devices connected to cellular and, for some situations, Wi-Fi networks. Additionally, the more embedded the Ad Trigger is into the Stream, the more likely the Client Media Player 103 will be unique to the Streaming Server System 100 and thus less likely to be well optimized for the hardware by the Client Device manufacturer. Pragmatically, embedding the Ad Trigger Meta Data into the Live Broadcast Video Stream presents the risk of performance issues for the Client Media Player and risk of high development and maintenance expense for the provider of the Client Media Player software.

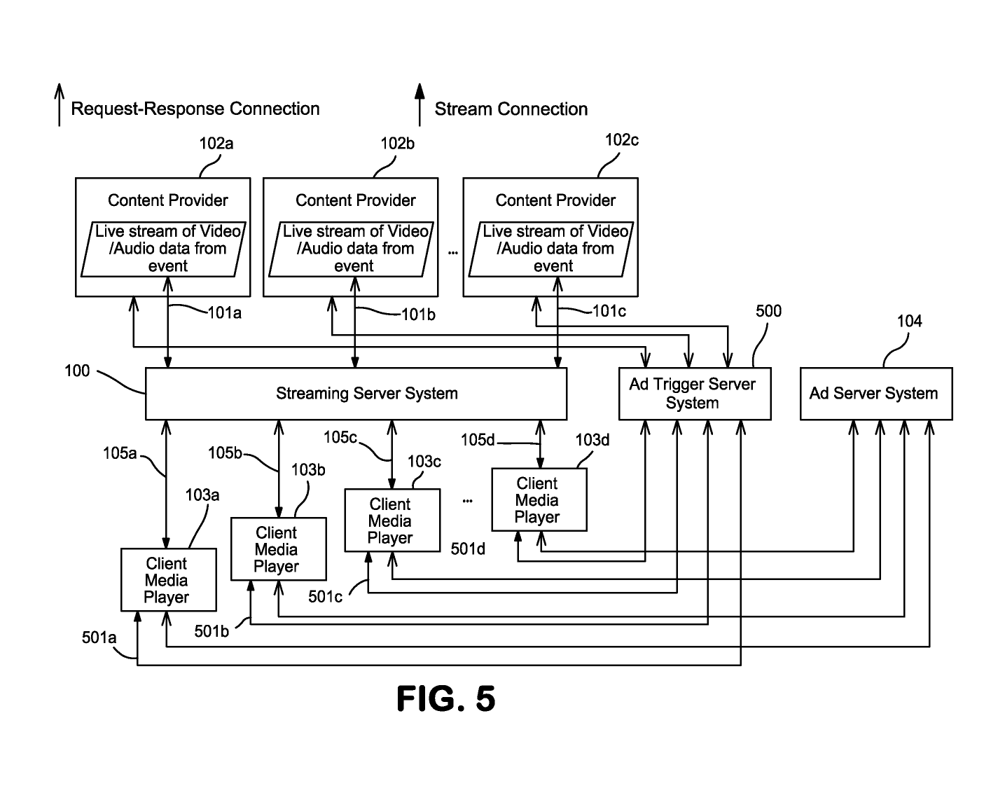

Referring now to the embodiments of the present disclosure in more detail, FIG. 5 illustrates exemplary systems, connected by digital networks, used in delivering a Live Broadcast Video Stream with Contextual Advertisements to a Client Media Player, in this case a Mobile Computing Device. Compared to FIG. 1, this illustration introduces the Ad Trigger Server System 500, a real time notification server system for the purpose of communicating Ad Trigger Meta Data as quickly as possible and without encumbering the Video Stream. The ad trigger server system 500 is coupled to both the content providers 102 and the client media players 105.

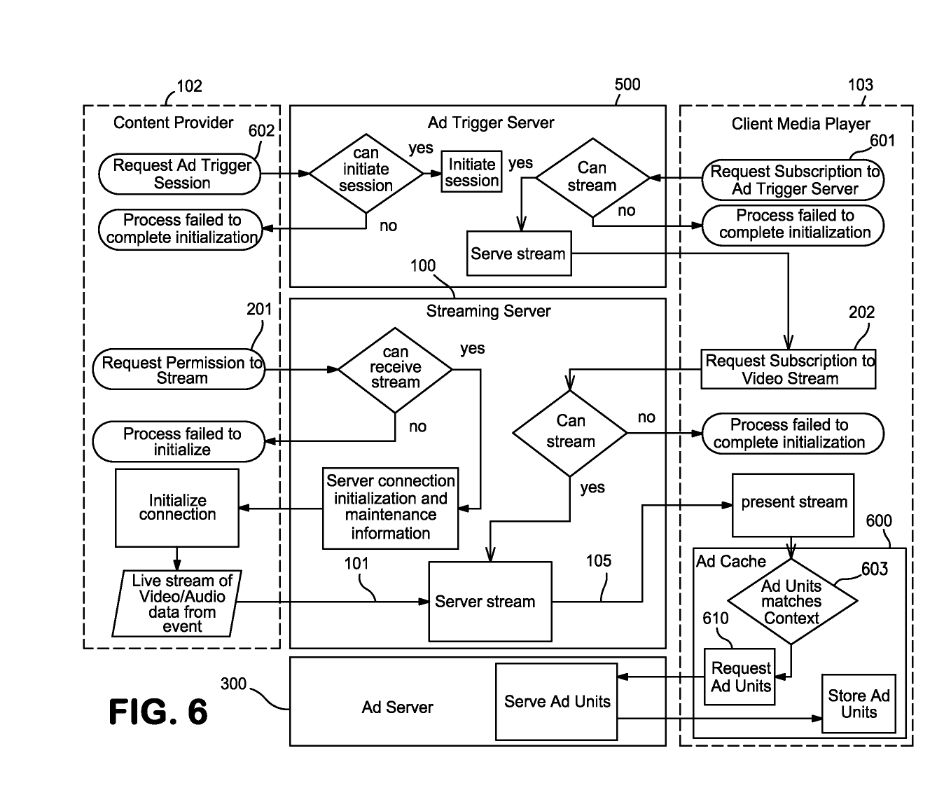

The process of initiating a Live Broadcast Video Stream is illustrated in FIG. 6. This process begins with the Content Provider 102 requesting permission 201 to deliver a Video Stream 101 to a Streaming Server System 100. If the Streaming Server System 100 cannot accept the Video Stream 101, it rejects the request and the process is not initiated. If the Streaming Server System 100 can accept the Video Stream 101, the Streaming Server System 100 responds to the Content Provider 102 with information to create and maintain the Video Stream 101 to the Streaming Server System 100. Also, the Content Provider 102 requests 602 an Ad Trigger Session from the Ad Trigger Server System 500. If the Ad Trigger Server System 500 cannot provide an Ad Trigger Session, it rejects the request and the initiation process stops. Likewise, a Client Media Player 103 can submit a request 202 for a subscription of the Live Broadcast Video Stream from the Streaming Server System 100 and simultaneously or serially submit a request 601 for a subscription to an Ad Trigger Stream 501 from the Ad Trigger Server System 500. If a server can provide its respective stream, that server sends the Client Media Player information to create and maintain the stream from the server. If either (Streaming Server System 100 or the Ad Trigger Server System 500) server cannot provide a Video Stream, the Server in question rejects the request. If the Client Media Player 103 receives a rejection from one of the servers or does not receive a response from one of the servers, the Client Media Player 103 will not complete initialization of the video streaming process.

In an embodiment, an optional Broadcast Context (not shown in the figures) may be introduced. During initialization of the Video Stream, the Client Media Player 103 can request from the Broadcast Context Server System any contextual data for the Live Broadcast Video Stream that should be used in the selection of Ad Units from the Ad Server System 300 or the Ad Cache 600. This and other contextual data can further refine the selection of Ad Units. The Broadcast Context contextual data can also give the Client Media Player 103 an estimate of how many Ad Units and of what duration are anticipated for the Live Broadcast Video Stream.

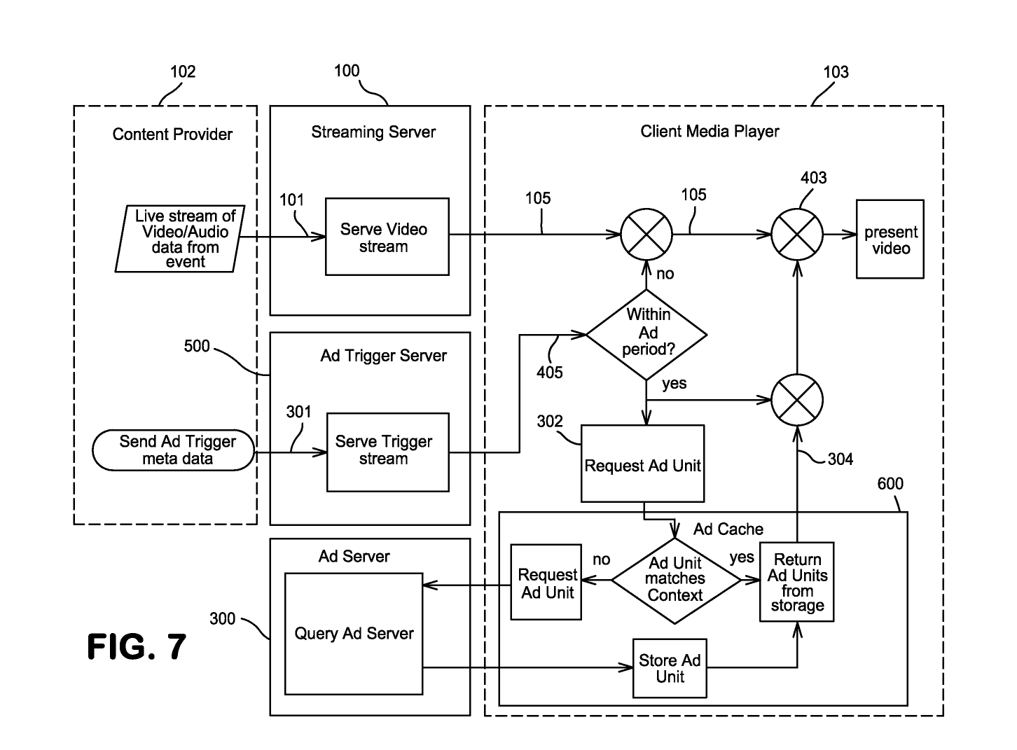

In an embodiment, the Client Media Player 103 may have an Ad Cache 600, which represents a storage dedicated to the storage of Ad Units 304. During Video Stream Initialization, as illustrated in FIG. 6, the Client Media Player 103 evaluates at 603 the Ad Units in the Ad Cache against its known contexts such as the Consumer Context, the Device Context, the Server Context and the optional Broadcast Context. Any Ad Units that compare favorably to the Media Client Player's Context and the optional Broadcast's Context are retained for injection during the Live Broadcast Video Stream. If there appears to be an insufficient quantity of Ad Units for the anticipated need (as indicated by the Broadcast Context) the Ad Cache can request 610 more Ad Units from the Ad Server System. In order for this to occur with minimum impact to performance, the Client Media Player 103 opens a side channel and preemptively downloads more Ad Units from the Ad Server System 300 to the Ad Cache 600. FIG. 7 illustrates how, with Ad Units stored in an Ad Cache 600, the Client Media Player 103 is now able to present Ad Units without the latency issues associated with real time communication with the Ad Server System.

FIG. 7 illustrates the process of injecting an ad unit into a Live Broadcast Video Stream. This process starts with the Content Provider 102 sending an Ad Trigger Meta Data 301 to the Ad Trigger Server System 500. Like the Streaming Server System 100, the Content Provider 102 has a one to one relationship to an Ad Trigger Server System 500 for a particular Content Stream. The Ad Trigger Server System 500 in turn broadcasts the Ad Trigger Meta Data 301 to the subscribing Client Media Players 103. The Client Media Player 103 uses the Ad Trigger Meta Data 301 as further contextual information for selecting an Ad Unit from the Ad Cache 600. In response to Ad Trigger Meta Data 301, the Client Media Player 103 switches from displaying the Live Broadcast Video Stream to displaying of the Ad Unit on a display of the Client Media Player 103. Switching of the display of the Ad Unit may be facilitated based on processing of the Ad Trigger Meta Data 301 by Client Media Player 103.

There are multiple advantages to this approach. Because Ad Injection is controlled by the Client Media Player 103, Ad Units can be chosen based on a larger set of contexts, such as, for example, Consumer Context, Device Context, and Broadcast Context. Also, because the Client Media Player 103 can be used as a subsystem in a more general application, there could be additional context information specific to the more general application that can also be used in Ad Unit selection. Because Ad Units are not requested from the Ad Server System at the time in which they are to be presented, they can be preemptively acquired from the Ad Server System on a side channel thereby using significantly less peak bandwidth than necessary for real time presentation. Preemptive acquisition includes acquiring Ad Units after completing the presentation of one Live Broadcast Video Stream for the purpose of using those acquired Ad Units for a future Live Broadcast Video Stream. Preemptively acquiring Ad Units enables the Ad Units to be presented without concern for delays from latency. Additionally, because Ad Trigger Meta Data is communicated by way of a side channel, a well-maintained and highly optimized media player codec provided by the device manufacturer or operating system vendor can be used instead of a proprietary media player codec or an in-stream filter.

To the extent that new Ad Units cannot be acquired in time for presentation before, during or after a Live Broadcast Video Stream, the system may recycle existing Ad Units for representation. Additionally, Ad Units may be preloaded, for example, by downloading, including during off peak hours when bandwidth usage is low or at a minimum or when bandwidth costs are low or at a minimum, or by insertion of storage media.

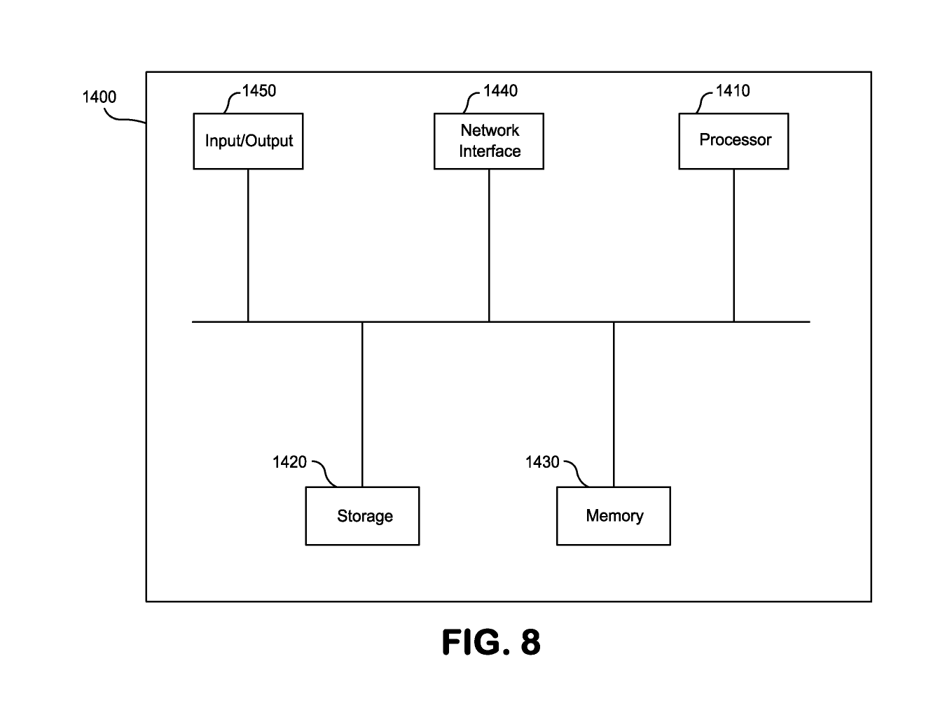

The above-described embodiments can be implemented on a computer using well-known computer processors, memory units, storage devices, computer software, and other components. A high-level block diagram of such a computer is illustrated in FIG. 8. Computer 1400 contains a processor 1410, which controls the overall operation of the computer 1400 by executing computer program instructions, which define such operations. The computer program instructions may be stored in a storage device 1420, or other computer readable medium (e.g., magnetic disk, CD ROM, etc.), and loaded into memory 1430 when execution of the computer program instructions is desired. Thus, any of the processes described herein can be defined by the computer program instructions stored in the memory 1430 and/or storage 1420 and controlled by the processor 1410 executing the computer program instructions. Accordingly, by executing the computer program instructions, the processor 1410 executes an algorithm for inserting advertisements as described herein. Computer 1400 may also perform other functionalities, such as those described above in connection with all Figures corresponding to the embodiments described herein. The computer 1400 also includes one or more network interfaces 1440 for communicating with other devices via a network. The computer 1400 also includes input/output devices 1450 that enable user interaction with the computer 1400 (e.g., display, keyboard, mouse, speakers, buttons, etc.) One skilled in the art will recognize that an implementation of an actual computer could contain other components as well, and that FIG. 14 is a high level representation of some of the components of such a computer for illustrative purposes.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim and all applications, modifications and variations that fall within the true scope of the present teachings.

1. A system for displaying an advertisement in conjunction with the presentation of digital content, comprising:
a medial player;
a streaming server, wherein the streaming server streams the digital content to the media player;
an ad server, wherein the ad server provides one or more advertisement to the media player; and
an ad trigger server, wherein the ad trigger server provides ad trigger data to the media player,
wherein the streaming server, ad server and ad trigger server are coupled to the media player at least one of wirelessly and via a physical connection, and wherein the media player comprises:
a software program;
a processor;
a display; and
an ad cache coupled to the processor, wherein upon receipt of ad trigger data from the ad trigger server the processor runs the software program and selects at least one of the digital content and the advertisement for presentation on the display.

2. A method for displaying an advertisement in conjunction with the presentation of digital content, comprising:
streaming digital content to a media player;
providing ad content to the media player for storage in an ad cache prior to the streaming of the digital content;
providing ad trigger data to the media player during the streaming of the digital content, wherein the ad trigger data includes information indicating at least one of a period of time during which ad content should be presented and a point in time at which the presentation of ad content should begin being presented on a user display during the streaming of the digital content; and
presenting the advertisement at least one of during the period of time during which ad content should be presented, and at or near the point in time at which the ad content should begin being presented on the user display.

3. The method of claim 2, wherein the media player comprises a software application on a microprocessor based display device.

4. A computer program product used with a processor, the computer program product comprising:
a non-transitory computer usable medium having computer readable program code embodies therein that is used for displaying an advertisement in conjunction with the presentation of digital content, the computer readable program code including:
computer readable program code used to stream digital content to a media player;
computer readable program code used to provide ad content to the media player for storage in an ad cache prior to the streaming of the digital content;
computer readable program code used to provide ad trigger data to the media player during the streaming of the digital content, wherein the ad trigger data includes information indicating at least one of a period of time during which ad content should be presented and a point in time at which the presentation of ad content should begin being presented on a user display during the streaming of the digital content; and
computer readable program code used to present the advertisement at least one of during the period of time, at the point in time and near the point in time.
